(19) United States
(12) Patent Application Publication
(10) Pub. No.: US 2011/0274169 A1
(43) Pub. Date: Nov. 10, 2011

(54) DEVICE, SYSTEM, AND METHOD FOR SPATIALLY ENCODING VIDEO DATA

(76) Inventor: Adar PAZ, Kefar-Sava (IL)

(21) Appl. No.: 12/774,087

(22) Filed: May 5, 2010

(51) Int. Cl. H04N 7/36

(52) U.S. Cl. 375/240.13; 375/E07.255

(57) ABSTRACT

A system, processor, and method are provided for spatially encoding a data block of digital video, such as an image frame, video stream, or other digital data. A processor may receive an uncompressed data block defining values for a set of pixels. A mode decision unit may determine a direction of pixel value change between the set of pixels and a set of adjacent pixels which belong to one or more previously encoded data blocks. The mode decision unit may compare the direction of pixel value change with each of a predefined plurality of different mode directions and may select the mode direction that most closely matches a direction of minimum pixel value change. A mode prediction unit may extrapolate values from the set of adjacent pixels in the selected mode direction. An encoder may use the extrapolated values to generate compressed data representing the uncompressed data block.

### BACKGROUND

The present invention relates to video and image applications, and more particularly to encoding a block of pixels, for example, in video and imaging applications, by extrapolating similar adjacent pixels to reduce spatial redundancies in video and image data.

Many different video compression mechanisms have been developed for effectively transmitting and storing digital video and image data. Compression mechanisms may use an “inter” coding mode to encode temporal changes between corresponding pixels in consecutive frames and/or an “intra” coding mode to encode spatial changes between adjacent pixels within a single frame.

Inter coding modes take advantage of the fact that consecutive frames in a typical video sequence are often very similar to each other. For example, a sequence of frames may have scenes in which an object moves across a stationary background, or a background moves behind a stationary object. Intra coding modes take advantage of the correlation among adjacent pixels to more efficiently transmit and store data. The respective intra (spatial) and inter (temporal) coding modes may be used together or separately to reduce the temporal and spatial redundancies in video data. However, as embodiments of the invention primarily relate to intra (spatial) coding modes, these modes are discussed in greater detail below.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings. Specific embodiments of the present invention will be described with reference to the following drawings, wherein:

FIGS. 1A and 1B shows a plurality of possible intra encoding modes helpful in understanding embodiments of the invention;

FIG. 2A is a schematic illustration of an exemplary device in accordance with embodiments of the invention;

FIG. 2B is a schematic illustration of an exemplary encoder unit in accordance with embodiments of the invention;

FIG. 3 is a schematic illustration of an exemplary data block to be encoded in accordance with embodiments of the invention;

FIGS. 4A and 4B are schematic illustrations of exemplary mechanisms for computing directional pixel value changes in accordance with embodiments of the invention; and

FIG. 5 is a schematic illustration of an exemplary vector field of the pixel value changes between a data block and adjacent pixels block in accordance with embodiments of the invention; and

FIG. 6 is a flowchart of a method for spatially encoding a data block of digital data in accordance with embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

An image or frame may be partitioned into macro blocks. A macro block may be a 16×16 data block (representing values for a 16×16 pixel array), which may be further partitioned into 16 sub-macro or 4×4 blocks (each representing values for a 4×4 pixel array). Other block sizes or arrangements may be used. In some standards, there are a plurality of different intra coding modes from which to choose for encoding each (e.g., 4×4) data block.

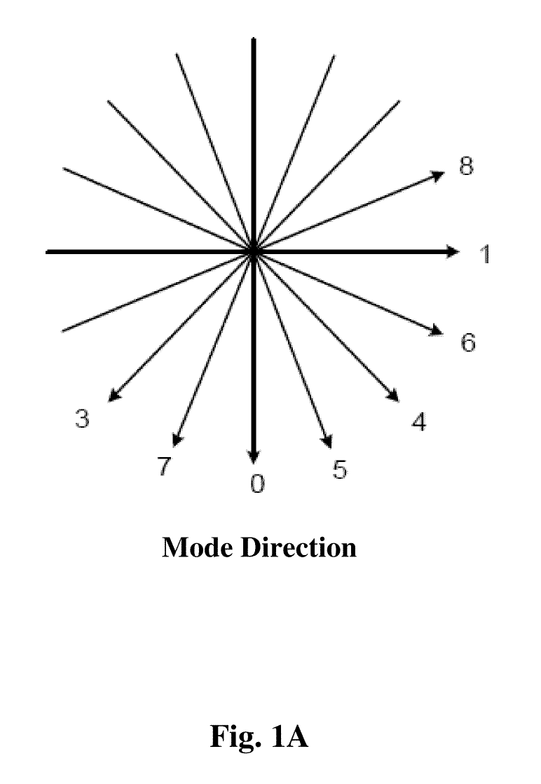

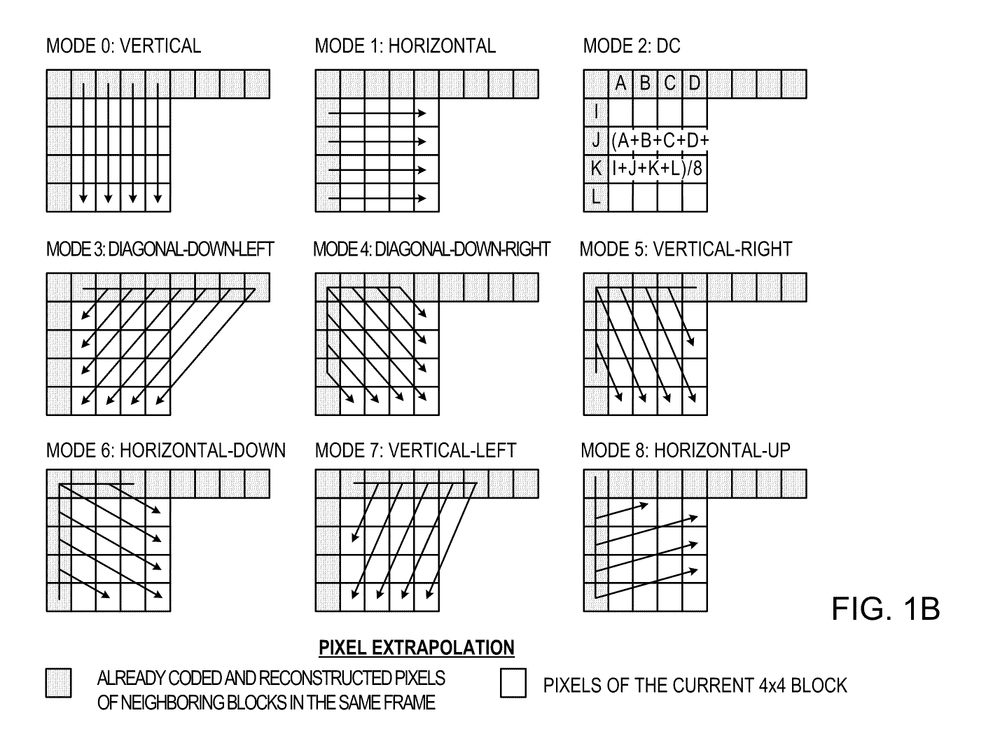

Reference is made to FIGS. 1A and 1B, which shows a plurality of alternative possible intra coding modes helpful in understanding embodiments of the invention. The example in the figure shows the nine different intra coding modes (0)-(8) in the H.264/Advanced Video Coding (AVC) standard for encoding 4×4 data blocks, which are listed for example, as follows:

| Intra4x4PredMode | |
|---|---|
| [luma4x4BlkIdx] | Name of Intra4x4PredMode[luma4x4BlkIdx] |
| 0 | Intra_4x4_Vertical (prediction mode) |
| 1 | Intra_4x4_Horizontal (prediction mode) |
| 2 | Intra_4x4_DC (prediction mode) |
| 3 | Intra_4x4_Diagonal_Down_Left (prediction |
| | mode) |
| 4 | Intra_4x4_Diagonal_Down_Right (prediction |
| | mode) |
| 5 | Intra_4x4_Vertical_Right (prediction mode) |
| 6 | Intra_4x4_Horizontal_Down (prediction mode) |
| 7 | Intra_4x4_Vertical_Left (prediction mode) |
| 8 | Intra_4x4_Horizontal_Up (prediction mode) |

In the figures, there are eight directional modes (e.g., modes 0, 1, and 3-8) and one non-directional mode (e.g., mode 2), which has no specific direction. Each directional intra coding mode may correspond to a different spatial direction for encoding pixel value changes in their respective directions, for example, as shown in the “Mode Direction” diagram of FIG. 1A. These directional intra coding modes extrapolate texture patterns in their respective directions using already encoded adjacent pixels, for example, as shown in the “Pixel Extrapolation” diagrams of FIG. 1B.

To choose the optimal mode, each intra coding mode may be tested. A “prediction block” may be generated for each mode approximating the currently-encoded data block by extrapolating already encoded pixels adjacent to the current block in the mode direction. To judge the quality of a prediction (or coding mode), the encoder may compute the difference or “residual data” between the predicted block and the original uncompressed data block. The optimal mode may be the mode that generates the most accurate prediction block and therefore has the minimum residual data. To find this “optimal” mode, the residual data for each alternative intra coding mode may be calculated (e.g., nine alternative mode calculations in the H.264 standard). This is referred to as the “mode-decision” operation. The mode-decision operation typically represents the bottleneck in most intra encoder systems. For example, approximately 50 percent of the intra encoding time may be consumed by the mode-decision operation. When considering the mode-decision operation separately from the other intra encoder functions, for example, over 80 percent of the processing time may be consumed by testing the nine different modes for the 4×4 blocks.

Embodiments of the invention may improve the efficiency of intra mode encoding, the mode-decision operation, and specifically, predicting the optimal one of a plurality of possible intra coding modes to encode each data block, as this yields the highest potential for speeding up the encoder.

In one embodiment of the invention, a mode decision unit may replace the conventional mode-decision operation, in which an optimal mode is chosen by calculating the residual data for each mode separately—a time consuming operation, with a new optimized mode-decision operation, in which an optimal mode is chosen by calculating the direction of minimum pixel change in each data block and choosing the matching directional mode. The direction of minimum pixel change has the greatest spatial redundancy and is therefore the preferred direction for extrapolating pixels. Calculating the direction of minimum pixel change is significantly less time consuming than calculating the residual data for every possible mode. Accordingly, the mode decision unit using the mode-decision operation optimized according to embodiments of the invention may significantly increase coding efficiency.

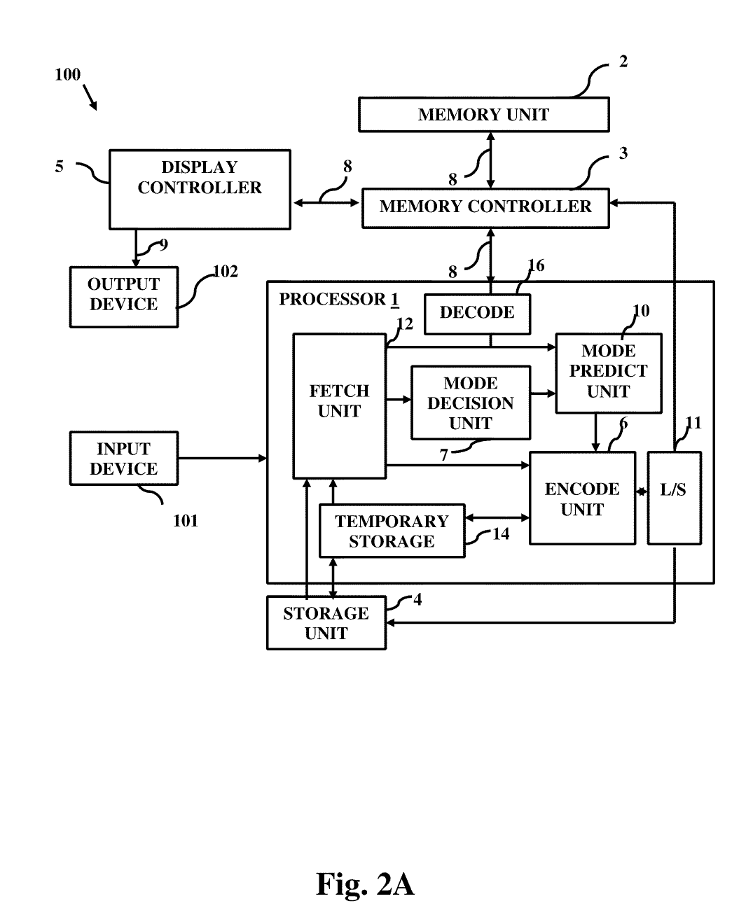

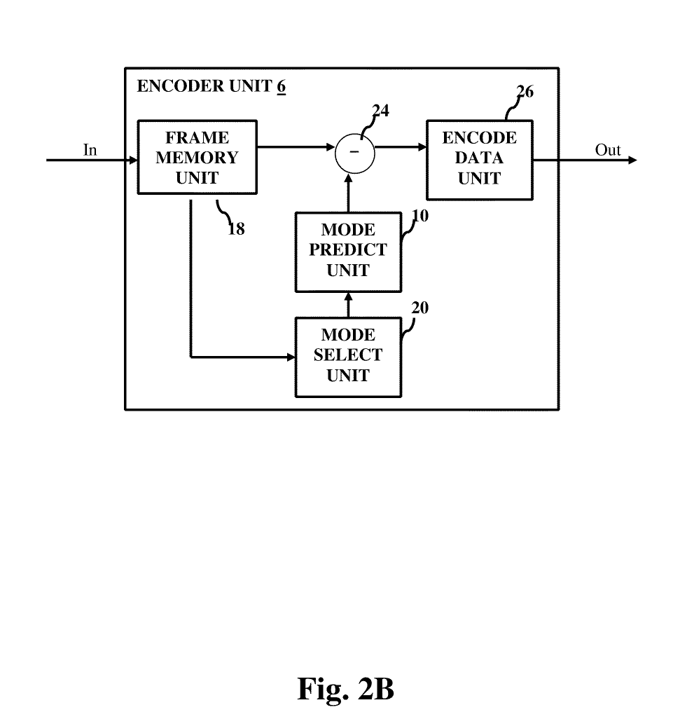

Reference is made to FIG. 2A, which is schematic illustration of an exemplary device in accordance with embodiments of the invention.

Device 100 may be a computer device, video or image capture or playback device, cellular device, or any other digital device such as a cellular telephone, personal digital assistant (PDA), video game console, etc. Device 100 may include any device capable of executing a series of instructions to record, save, store, process, edit, display, project, receive, transfer, or otherwise use or manipulate video or image data. Device 100 may include an input device 101. When device 100 includes recording capabilities, input device 101 may include an imaging device such as a camcorder including an imager, one or more lens(es), prisms, or mirrors, etc. to capture images of physical objects via the reflection of light waves therefrom and/or an audio recording device including an audio recorder, a microphone, etc., to record the projection of sound waves thereto.

When device 100 includes image processing capabilities, input device 101 may include a pointing device, click-wheel or mouse, keys, touch screen, recorder/microphone using voice recognition, other input components for a user to control, modify, or select from video or image processing operations. Device 100 may include an output device 102 (for example, a monitor, projector, screen, printer, or display) for displaying video or image data on a user interface according to a sequence of instructions executed by processor 1.

An exemplary device 100 may include a processor 1. Processor 1 may include a central processing unit (CPU), a digital signal processor (DSP), a microprocessor, a controller, a chip, a microchip, a field-programmable gate array (FPGA), an application-specific integrated circuit (ASIC) or any other integrated circuit (IC), or any other suitable multi-purpose or specific processor or controller.

Device 100 may include a data memory unit 2 and a memory controller 3. Memory controller 3 may control the transfer of data into and out of processor 1, memory unit 2, and output device 102, for example via one or more data buses 8. Device 100 may include a display controller 5 to control the transfer of data displayed on output device 102 for example via one or more data buses 9.

Device 100 may include a storage unit 4. Data memory unit 2 may be a short-term memory unit, while storage unit 4 may be a long-term memory unit. Storage unit 4 may include one or more external drivers, such as, for example, a disk or tape drive or a memory in an external device such as the video, audio, and/or image recorder. Data memory unit 2 and storage unit 4 may include, for example, random access memory (RAM), dynamic RAM (DRAM), flash memory, cache memory, volatile memory, non-volatile memory or other suitable memory units or storage units. Data memory unit 2 and storage unit 4 may be implemented as separate (for example, “off-chip”) or integrated (for example, “on-chip”) memory units. In some embodiments in which there is a multi-level memory or a memory hierarchy, storage unit 4 may be off-chip and data memory unit 2 may be on-chip. For example, data memory unit 2 may include an L-1 cache or an L-2 cache. An L-1 cache may be relatively more integrated with processor 1 than an L-2 cache and may run at the processor clock rate whereas an L-2 cache may be relatively less integrated with processor 1 than the L-1 cache and may run at a different rate than the processor clock rate. In one embodiment, processor 1 may use a direct memory access (DMA) unit to read, write, and/or transfer data to and from memory units, such as data memory unit 2 and/or storage unit 4. Other or additional memory architectures may be used.

Storage unit 4 may store video or image data in a compressed form, while data memory unit 2 may store video or image data in a uncompressed form; however, either compressed or uncompressed data may be stored in either memory unit and other arrangements for storing data in a memory or memories may be used. Uncompressed data may be represented in a multi-dimensional data array (for example, a two or three dimensional array of macro blocks), while compressed data may be represented as a one-dimensional data stream or data array. Each uncompressed data element may have a value uniquely associated with a single pixel in an image or video frame (e.g., a 16×16 macro block may represent a 16×16 pixel array), while compressed data elements may represent a variation or change in pixel values. Compressed data from inter frame coding mechanisms may indicate a temporal change between the values of corresponding pixels in consecutive frames in a video stream. Compressed data from intra frame coding mechanisms may indicate a spatial change in values between adjacent pixels in a single image frame. When used herein, unless stated otherwise, encoding, modes for encoding, and the compressed data generated thereby, refer to intra (spatial) encoding mechanisms.

Processor 1 may include a fetch unit 12, a mode decision unit 7, a mode prediction unit 10, and an encode unit 6.

To encode or compress video or image data, processor 1 may send a request to retrieve uncompressed data from data memory unit 2. The uncompressed data may include macro blocks (e.g., representing 16×16 pixel arrays) divided into sub-macro blocks (e.g., representing 4×4 pixel arrays). Processor 1 may indicate a specific memory address for retrieving each uncompressed data block or may simply request the next sequentially available data. Fetch unit 12 may retrieve or fetch the uncompressed data from data memory unit 2, for example, as individual pixel values, in data blocks, or in “bursts.” A burst may include data across a single row of pixels. Since each (e.g., 4×4) data block spans multiple (e.g., four) rows, processor 1 may retrieve multiple (e.g., four) bursts in order to form a complete (e.g., 4×4) data block. Other numbers, arrangements, sizes and types of data or data blocks may be used, for example, including 4×8, 8×4, 4×16, 8×16, 16×16, . . . data blocks, a one-dimensional string of data bits, or three-dimensional data arrays. The uncompressed data may be stored in temporary storage unit 14, which may be, for example, a buffer or cache memory.

In conventional systems, a mode prediction unit may select the intra coding mode by repeatedly running the same mode prediction operations on a data block for each and every possible mode. For each mode, the mode prediction operations for each data block may include (a) generating a “prediction block” approximating the data block by applying the mode directional vector to already encoded pixels surrounding the data block, then (b) computing the difference or “residual data” between the predicted block and the original uncompressed data block, and finally (c) comparing the residual data for the current mode with the residual data for other modes. The most accurate of the plurality of possible modes is the one mode which generates a prediction block most similar to the actual data block, i.e., which has the smallest residual data. For example, if the mode perfectly encodes the data block, the residual data may be zero. Thus, the mode that generates the smallest residual data may be selected to encode the data block. These mode prediction operations (a)-(c) are time consuming, especially when executed for every possible intra coding mode (for example, nine modes in the H.264/AVC standard). This process is repetitive, inefficient, and is typically the bottleneck of conventional intra mode encoding.

According to embodiments of the invention, the optimal intra coding mode may be determined without using mode prediction operations (a)-(c) or mode prediction unit 10, and instead, using mode decision unit 7.

Each data block may be encoded by extrapolating or copying pixel values from already encoded adjacent pixels to generate a prediction block. Each intra coding mode defines a distinct direction in which the pixel values are copied (for example, as shown in FIG. 1A). Mode decision unit 7 may use a unique criterion, for example, the spatial direction of minimum pixel value change for each data block, to select the optimal mode to encode the data block. The direction of minimum value change has the most redundant and similar pixel values and is therefore the optimal direction across which to copy adjacent pixel values. Mode decision unit 7 may select the mode that most closely corresponds to that direction. It is that mode that may generate the most accurate predicted block with the smallest residual data. Any other directions (corresponding to other modes) would copy the same pixel values in a direction having less constant and more deviating pixel values. These other modes would thereby generate a prediction block that, on average, has a greater deviation in pixel values from the original uncompressed data block. Accordingly, the mode selected by mode decision unit 7 is known to generate the most accurate predicted block with the least residual data, for example, without using mode prediction unit 10 to actually generate and test each predicted block or its residual data beforehand.

Once the optimal intra coding mode is selected, the data block and the selected mode may be issued to mode prediction unit 10. Mode prediction unit 10 may perform operations (a) and (b) on the data block using the intra coding mode selected by mode decision unit 7. For example, mode prediction unit 10 may generate a prediction block using already encoded pixels in the spatial proximity of the current data block and may compute residual data between the predicted block and the original uncompressed data block.

As compared with conventional mechanisms, which repeatedly execute mode prediction operations (a)-(c) on a data block for each and every mode (e.g., 9 times in the H.264/AVC standard), according to embodiments of the invention, since the optimal mode is already selected prior to executing mode prediction operations, operations (a) and (b) are only executed once for each data block and operation (c) is not executed at all. Accordingly, embodiments of the invention provide more than an 8-fold increase in the efficiency of the mode prediction operations in the H.264/AVC standard, the most time-consuming operation of the intra coding process. To further distinguish conventional mechanisms, which use the mode prediction operations to select an optimal intra coding mode, in contrast, embodiments of the invention select the optimal mode prior to executing the prediction operations and the prediction operations are simply used to generate residual data for encoding the data blocks.

Reference is made to FIG. 2B, which is schematic illustration of an exemplary encoder unit 6, in accordance with embodiments of the invention. Encoder unit 6 may receive input data for each data block including, for example, image data (e.g., from temporary storage 14 or directly from fetch unit 12) and the corresponding selected intra coding mode (e.g., from mode decision unit 7). The input data may be stored in a frame memory unit 18, which may be the same or separate from temporary storage 14 and, which may be integral, attached, or directly accessible to encoder unit 6.

An intra coding mode selection unit 20 may retrieve the intra coding mode selected for each data block from frame memory unit 18 and mode prediction unit 10 may generate a prediction block by extrapolating already encoded pixels adjacent to the current data block in the selected intra coding mode direction.

An arithmetic logic unit (ALU) 24 may retrieve the current data block from frame memory unit 18 and the corresponding prediction block from mode prediction unit 10 and generate the residual data block to be the difference therebetween.

Once a mode is selected and the corresponding prediction block and residual data are generated, encode data unit 26 may generate compressed data that fully defines each original uncompressed data block. In one embodiment, the original block may be fully defined by an approximation, for example, the prediction block, and the error of the approximation, for example, the residual data. Since the prediction block is generated by applying a mode direction vector to a pre-designated set of adjacent pixels, the prediction block may be fully defined by the selected mode. Accordingly, the compressed data for each uncompressed data block may include a mode and its corresponding residual data.

In one embodiment, each mode in the H.264/AVC standard may be represented, for example, by one to four data bits. For example, only a single bit may be used to indicate that the mode for the currently coded or current block is the same as the mode for the previous block (e.g., designated by a bit value of zero (0) or one (1)). If the mode is different however, an additional three bits may be used (providing 2³=8 different values) to indicate the remaining eight of the nine modes in the H.264/AVC standard. In another embodiment, nine of the 2⁴=16 different values of four bits may each correspond to one of the nine intra 4×4 coding modes in the H.264/AVC standard. Other representations, configurations, and numbers of bits may be used to encode the modes.

The residual data for each data block may also be compressed. Initially, the residual data may be represented as a data block itself (for example, a 4×4 data block defined by the matrix difference between the original and prediction 4×4 data blocks). The residual data block may be compressed, for example, by a discrete cosine transformation (DCT) that defines the coefficients of the residual data block.

Encode data unit 26 may generate encoded output data to encode an image frame or video stream. The encoded output data for a digital image frame may include a string of encoded bits, where each sequential group of bits may encode a data block for a spatially sequential array of pixels in the digital image frame. In one example, each 4×4 pixel array may be represented by, for example, 1-4 bits defining a mode and additional bits defining the DCT of the corresponding residual data.

Encoder unit 6 may issue the string of encoded output data to a load/store unit 11, for transferring the compressed data. In one embodiment, load/store unit 11 may transfer the encoded data to storage unit 4 for long-term storage. Alternatively, store unit 11 may transfer the encoded data to temporary storage 14 for further processing, for example, by an execution unit. In another embodiment, load/store unit 11 may transfer the encoded data to output device 102, either directly of via memory controller 3, for example, for transmitting or streaming the data to another device.

To display the video or image data, a decoder unit 16 may convert the compressed encoded data into uncompressed data (decoding), for example, by inverting the operations for encoding. In one embodiment, decoder unit 16 may generate a prediction block by applying the mode direction vector to a pre-designated set of adjacent pixels (which were already uncompressed from decoding the previous block), convert the DCT residual data bits into a 4×4 residual data block, and add the prediction block and the residual data block to generate the original uncompressed data block. The uncompressed data block may be displayed in an image frame or video stream on output device 102 (such as, a monitor or screen), for example, via display controller 5.

Mode decision unit 7, mode prediction unit 10, and/or decoder unit 16 may be integral to or separate from encoder unit 6 and/or processor 1 and may be operatively connected and controlled thereby. These devices may be internal or external to device 100. Other components or arrangements of components may be used.

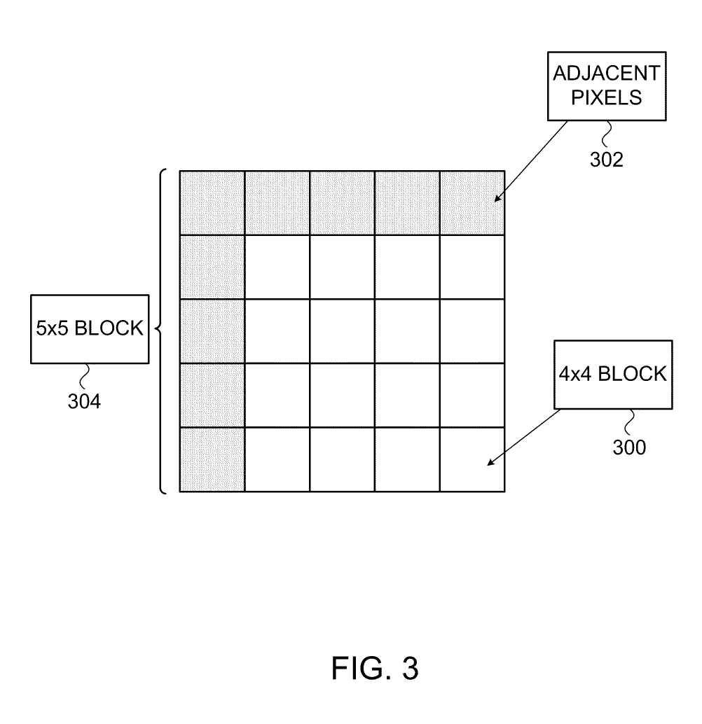

Reference is made to FIG. 3, which is schematic illustration of an exemplary data block 300 to be encoded in accordance with embodiments of the invention.

A processor (e.g., processor 1 of FIG. 2A) may receive data block 300 representing video, image, or other digital data. In the example in FIG. 3, data block 300 is a 4×4 data block (for example, representing values for a 4×4 pixel array), although any sized data block may equivalently be used.

The processor may generate a “meta” block 304, which includes data block 300 combined with its adjacent pixel blocks 302. Meta block 304 may be used to generate a prediction block of data block 300 by extrapolating values from adjacent pixel blocks 302. In the example in FIG. 3, meta block 304 is a 5×5 data block (for example, representing values for a 5×5 pixel array), although any sized data block may equivalently be used.

The processor may use adjacent pixel blocks 302 from previously encoded data blocks for encoding the current data block 300. When adjacent pixel blocks 302 are initially encoded, they may be stored in a temporary storage area (e.g., in temporary storage 14 of FIG. 2A) until they are used to process the current data block 300.

Adjacent pixel blocks 302 may represent pixels adjacent to, neighboring, or within a predetermined pixel length or pixel value difference of, pixels represented by the current data block 300. Adjacent pixels defined by adjacent pixel blocks 302 may be pre-designated in a particular spatial position relative to current pixels represented by the current data block 300. In the example in FIG. 3, adjacent pixel blocks 302 represent pixels above and to the left of pixels represented by the current data block 300. In this example, adjacent pixel blocks 302 may be taken from three previously encoded data blocks, for example, the data blocks above, to the left and diagonally to the upper-left. Alternatively, adjacent pixel blocks 302 may be taken from a subset of the surrounding data blocks (e.g., only above and to the left) and any intermediate or additional surrounding pixels (e.g., diagonally to the upper-left) may be left out or averaged, duplicated, or derived from other adjacent pixel blocks. It may be appreciated that adjacent pixel blocks 302 may represent any pixels from an area neighboring the current pixels being encoded or from a greater distance if there is sufficiently minimal pixel value change therebetween. The pre-designated area or relative spatial position, the number or dimensions of adjacent pixel blocks 302, the size of the neighborhood or threshold for a degree of permissible pixel value change in a neighborhood may be pre-programmed, changed by a user (for example, to adjust the encoding speed and/or quality), and/or automatically and iteratively adjusted by the processor to maintain a predetermined encoding efficiency.

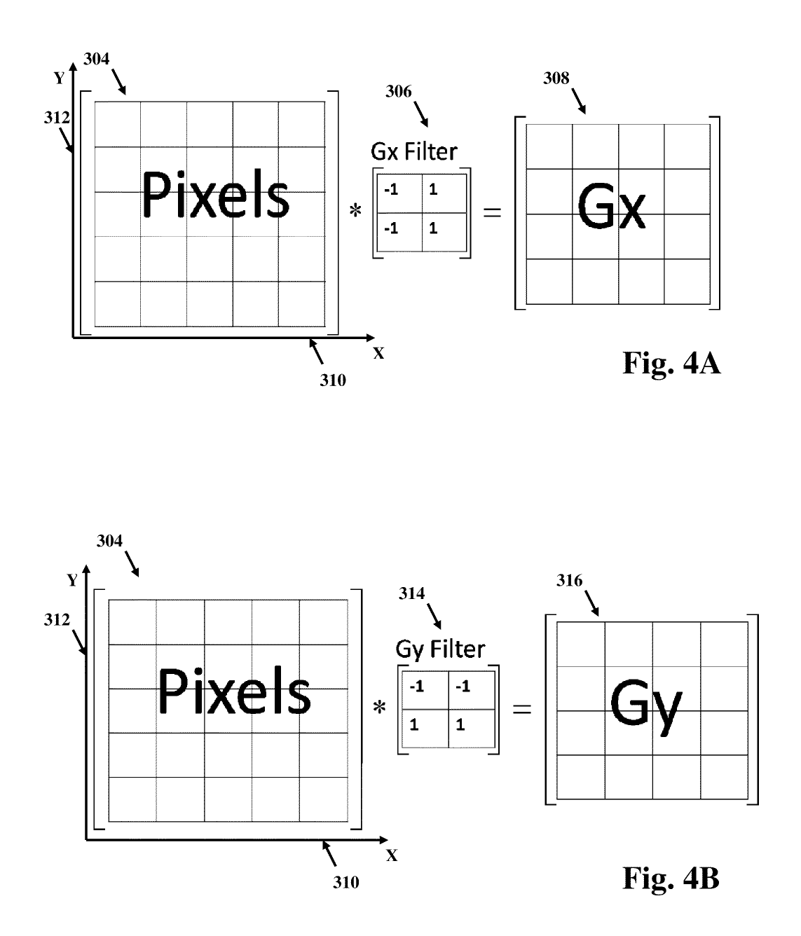

The processor may select a mode with a directionality closest to the direction of minimum pixel value change across meta block 304 (e.g., data block 300 and adjacent pixel blocks 302 combined). The processor may measure the pixel value change in two or more distinct predetermined directions and may combine the changes in the respective predetermined directions (e.g., by vector addition) to determine a direction of pixel change. Any two or more distinct predetermined directions may be used, such as, for example, perpendicular or non-parallel directions or the respective directions of any coordinate system, such as, distance and angle in the polar coordinate system. The accuracy of pixel value change calculations may be increased by increasing the number of predetermined directions along which the pixel value changes are measured. In FIGS. 4A and 4B, the change may be measured in the “X” and “Y” directions of the Cartesian coordinate system.

Reference is made to FIGS. 4A and 4B, which schematically illustrate exemplary mechanisms for computing pixel value changes in an X direction 310 and a Y direction 312, respectively, in accordance with embodiments of the invention.

In FIG. 4A, to compute the pixel value change in X direction 310, a processor (e.g., processor 1 of FIG. 2A) may apply an X direction gradient filter 306 to meta block 304 to calculate differences in the values of pixels positioned along X direction 310. Applying gradient filter 306 to meta block 304 may generate an X direction gradient block 308 representing the changes in pixel values in X direction 310.

In one example, gradient block 308 may be the convolution of meta block 304 with an X direction gradient filter 306, for example,

$$Gx = [ \begin{matrix}- 1 & 1 \\ - 1 & 1\end{matrix} ] .$$

In this example, each entry, b_{i,j}, of gradient block 308 may correspond to a 2×2 sub-block of meta block 304,

$$[ \begin{matrix}{a}_{i , j} & {a}_{i , j + 1} \\ {a}_{i + 1 , j} & {a}_{i + 1 , j + 1}\end{matrix} ] ,$$

where b_{i,j}=[(a_{i,j})+(a_{i+,j})]−[(a_{i,j+1})+(a_{i+1,j+1})].

In the following example, values are arbitrarily assigned to meta block 304 for demonstrative purposes.

Meta block 304 is, for example:

$$[ \begin{matrix}10 & 10 & 10 & 10 & 10 \\ 20 & 20 & 20 & 20 & 20 \\ 30 & 30 & 30 & 30 & 30 \\ 41 & 41 & 42 & 43 & 44 \\ 50 & 52 & 54 & 56 & 58\end{matrix} ] \qquad ( 1 )$$

Applying gradient filter 306,

$$[ \begin{matrix}- 1 & 1 \\ - 1 & 1\end{matrix} ] ,$$

to convolve the exemplary meta block 304 in equation (1) generates an X direction gradient block 308, which is:

$$Gx = [ \begin{matrix}0 & 0 & 0 & 0 \\ 0 & 0 & 0 & 0 \\ 0 & - 1 & - 1 & - 1 \\ - 2 & - 3 & - 3 & - 3\end{matrix} ] \qquad ( 2 )$$

Similarly, in FIG. 4B, to compute the pixel value change in Y direction 312, a processor (e.g., processor 1 of FIG. 2A) may apply a Y direction gradient filter 314 to meta block 304 to calculate differences in the values of pixels positioned along Y direction 312. Applying gradient filter 314 to meta block 304 may generate a Y direction 312 gradient block 316 representing the changes in pixel values in Y direction 312.

In one example, gradient block 316 may be the convolution of meta block 304

with a Y direction gradient filter 314, for example,

$$Gy = [ \begin{matrix}- 1 & - 1 \\ 1 & 1\end{matrix} ] .$$

In this example, each entry, c_{i,j}, of gradient block 316 may correspond to a 2×2 sub-block of meta block 304,

$$[ \begin{matrix}{a}_{i , j} & {a}_{i , j + 1} \\ {a}_{i + 1 , j} & {a}_{i + 1 , j + 1}\end{matrix} ] ,$$

where c_{i,j}=[(a_{i,j})+(a_{i,j+1})]−[(a_{i+1,j})+(a_{i+1,j+1)].}

Applying gradient filter 306,

$$[ \begin{matrix}- 1 & 1 \\ - 1 & 1\end{matrix} ] ,$$

to convolve the exemplary meta block 304 in equation (1) generates a Y direction gradient block 316, which is:

$$Gy = [ \begin{matrix}- 20 & - 20 & - 20 & - 20 \\ - 20 & - 20 & - 20 & - 20 \\ - 22 & - 23 & - 25 & - 27 \\ - 20 & - 23 & - 25 & - 27\end{matrix} ] \qquad ( 3 )$$

Once the pixel value changes are calculated for each respective direction (for example, X direction 310 and Y direction 312), the processor may combine these values. X and Y gradient blocks 308 and 316 may be combined, for example, to form a multi-directional gradient block G=[Gx, Gy], where each entry Gᵢⱼ=Gxᵢⱼ, Gyᵢⱼ). Combining the exemplary X and Y (2D) gradient blocks 308 and 316 in equations (2) and (3) above generates a multi-directional (3D) gradient block, G, which is:

$$G = [ Gx , Gy ] = [ \begin{matrix}( 0 , - 20 ) & ( 0 , - 20 ) & ( 0 , - 20 ) & ( 0 , - 20 ) \\ ( 0 , - 20 ) & ( 0 , - 20 ) & ( 0 , - 20 ) & ( 0 , - 20 ) \\ ( 0 , - 22 ) & ( - 1 , - 23 ) & ( - 1 , - 25 ) & ( - 1 , - 27 ) \\ ( - 2 , - 20 ) & ( - 3 , - 23 ) & ( - 3 , - 25 ) & ( - 3 , - 27 )\end{matrix} ] \qquad ( 4 )$$

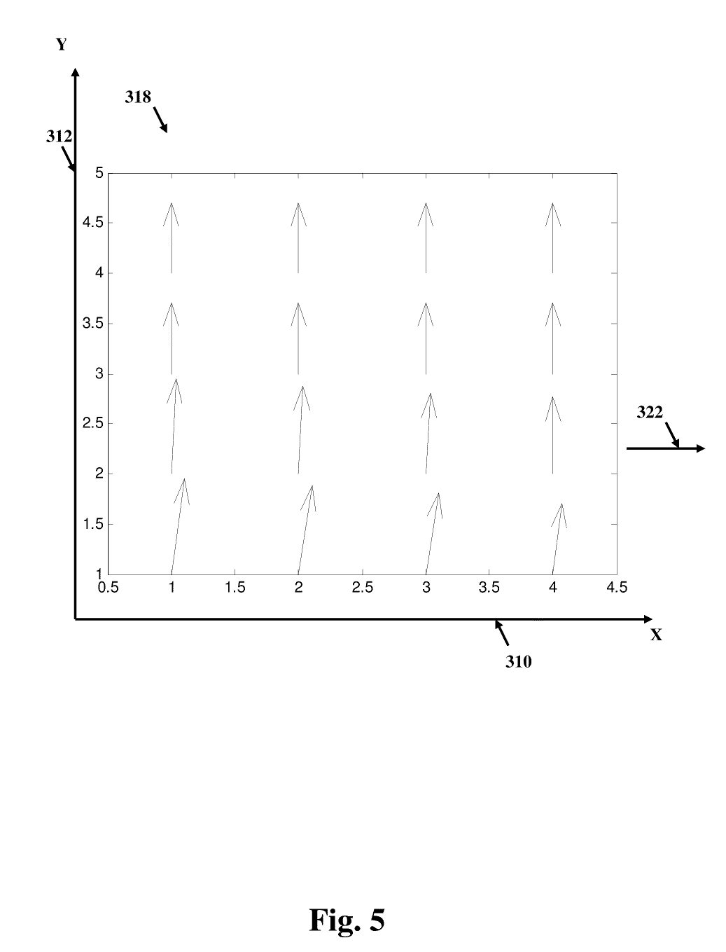

The (3D) multi-directional gradient block, G, defines an array of (2D) vectors, each indicating a direction and amplitude of pixel value change across meta block 304. A scaled version of the vector array is shown in FIG. 5.

Reference is made to FIG. 5, which schematically illustrates an exemplary vector field of the pixel value changes 318 across meta block 304, in accordance with embodiments of the invention.

A direction of minimum pixel value change 322 may be perpendicular to the vector field of pixel values changes 318. In the example shown in FIG. 5, the vector field of pixel value changes 318 is predominantly oriented in Y direction 312. Accordingly, the direction of minimum pixel value change 322 may be in X direction 310.

The processor may select an intra coding mode with a corresponding vector direction closest to the direction of minimum pixel value change 322 and therefore, perpendicular to the vector field of pixel value changes 318.

To determine the perpendicular direction, scalar products may be used. A scalar product between two vectors is maximal when the vectors are parallel and minimal when the vectors are perpendicular. Accordingly, to determine the optimal mode direction (for example, the mode direction that is most perpendicular to the vector field of pixel values changes 318) the processor may compute the scalar product of each mode direction vector (e.g., shown in FIG. 1A) and the vector field of pixel values changes 318. The scalar product giving a minimal value may correspond to the most perpendicular, and therefore, most optimal, mode direction. This scalar product for each mode may be referred to as the “energy” of the mode, E_{mode}.

In the example in FIG. 1A, the eight directional mode vectors may be represented as eight unit or direction vectors, “dir_{vec(Mode)},” for example, as follows:

dir_{vec(Mode)}=

[0,1] //Mode 0(Y direction 312)

[sin(1*pi/8),cos(1*pi/8)];//Mode 7

[sin(2*pi/8),cos(2*pi/8)];//Mode 3(positive X direction 310;positive Y direction 312)

[sin(3*pi/8),cos(3*pi/8)];//Mode 8

[sin(4*pi/8),cos(4*pi/8)];//Mode 1(X direction 310)

[sin(5*pi/8),cos(5*pi/8)];//Mode 6

[sin(6*pi/8),cos(6*pi/8)];//Mode 4(positive X direction 310;negative Y direction 312)

[sin(7*pi/8),cos(7*pi/8)],//Mode 5 (5)

where each sequential mode direction vector differs by an angle of 22½ degrees, and together the mode vectors span 180°. Other directions and angles may be used.

The “energy” for the each mode, E_{mode}, may be computed, for example, as:

E_{mode}=Σ [symbol] abs(G [symbol] ᵢ·dir_{vec(mode)}), (6)

where dir_{vec(Mode)} is the direction vector for each respective mode. Using the exemplary values of dir_{vec(Mode)} in equations (5) and the multi-directional gradient block, G, defined in equation (4), the energy for each mode defined in equation (6) is, for example:

E₀₌352.0000//Mode 0(Y direction 312)

E₇₌330.5632//Mode 7

E₃₌258.8011//Mode 3(positive X direction 310;positive Y direction 312)

E₈₌147.6389//Mode 8

E₁₌14.0000//Mode 1(X direction 310)

E₆₌121.7703//Mode 6

E₄₌239.0021//Mode 4(positive X direction 310;negative Y direction 312)

E₅₌319.8480//Mode 5 (7)

Other energy values may be used.

The processor may compare the energy calculated for each mode. The mode direction vector that generates the smallest “energy” or scalar product is most perpendicular to the vector field of pixel values changes 318 and therefore closest to the direction of minimum pixel value change 322. This mode is the optimal directional mode for providing the most accurate approximation of data block 300. For the exemplary values given in equation (7), mode 1 (purely horizontal, X direction 310) has the smallest energy (14.0000) of all the modes and is therefore the optimal directional mode in this example.

If only directional modes are used, the optimal directional mode may be automatically selected for encoding data block 300. However, some systems may use non-directional modes. A non-directional mode may be any mode that does not extrapolate adjacent pixel blocks 302 in a specific direction. For example, “DC” mode (2) shown in FIG. 1B is a non-directional mode that extrapolates prediction block by averaging the values of adjacent pixel blocks 302 (e.g., see Mode 2: DC of “Pixel Extrapolation” diagram of FIG. 1B).

Non-directional modes may be chosen over even the most accurate of the directional modes, for example, when there is no dominant or significant directionality of pixel value change across meta block 304. In another embodiment, encoding with non-directional modes may be significantly less computationally intensive than with directional modes, and therefore, even when there is a dominant or significant directionality of pixel change, if the directional amplitude is below a predetermined threshold, the non-directional modes may still be chosen.

The processor may evaluate the benefit of using the optimal directional mode over the other directional modes. If the benefit in insignificant or below a predetermined value, the processor may select a non-directional mode for encoding data block 300.

In one embodiment, the processor may select the optimal directional mode over the non-directional mode if the energy of the optimal directional mode is less than the sum of the energies of all other modes,

$${E}_{{mode}_{Total}} = {\sum }_{i = 0}^{8} {E}_{{mode}_{i}} ,$$

divided by a scaling factor, a. For example, the processor may select the optimal directional mode, if:

E₁(mode₁chosen)< [symbol] (E [symbol] ₁(mode₁Total)/a)) (8)

Otherwise, the processor may select a non-directional mode.

The scaling factor “a” may be adjusted to fine-tune the preference between the optimal directional mode and non-directional modes. The larger the scaling factor, the smaller the allowable energy of the directional mode and the greater the preference for selecting a non-directional mode. The scaling factor may be at least equal to the number of modes being summed so that equation (8) requires that the optimal directional mode has less than the average mode energy.

For the exemplary values given in equation (7), and for a scaling factor a=8, equation (8) requires that

$${E}_{1} ≺ ( \frac{sum ( E )}{8} ) ;$$

which is satisfied in this example. Therefore, the optimal directional mode (1) is selected over the non-directional mode (2).

Once the intra coding mode is selected for encoding data block 300, the processor may send the selected mode to the mode prediction unit (e.g., mode prediction unit 10 of FIGS. 2A and 2B) to generate a prediction block and residual data using the corresponding mode. The processor may send the selected mode and residual data to the encoder unit (e.g., encoder unit 6 of FIGS. 2A and 2B), where the residual data and/or mode may be further compressed for encoding data block 300 as a string of data bits.

This process may be repeated for each block in a macro block and each macro block in an image frame or video stream. During compression, or alternatively, only after an entire image frame or video stream is compressed, the encoder unit may issue the compressed data to a load/store unit (e.g., load/store unit 11 of FIG. 2A) for transferring, for example, for storage (e.g., in storage unit 4 or temporary storage 14 of FIG. 2A) or to an output device (e.g., output device 102 of FIG. 2A) for transmitting or streaming the data to another device, system, network.

A decoder (e.g., decoder unit 16 of FIG. 2A) may retrieve the compressed data from storage and convert the data into uncompressed data. The uncompressed image frame or video stream may be displayed on output device (for example, output device 102 of FIG. 2A, such as a monitor or screen). Other operations or series of operations may be used, and the exact set of operations shown above may be varied.

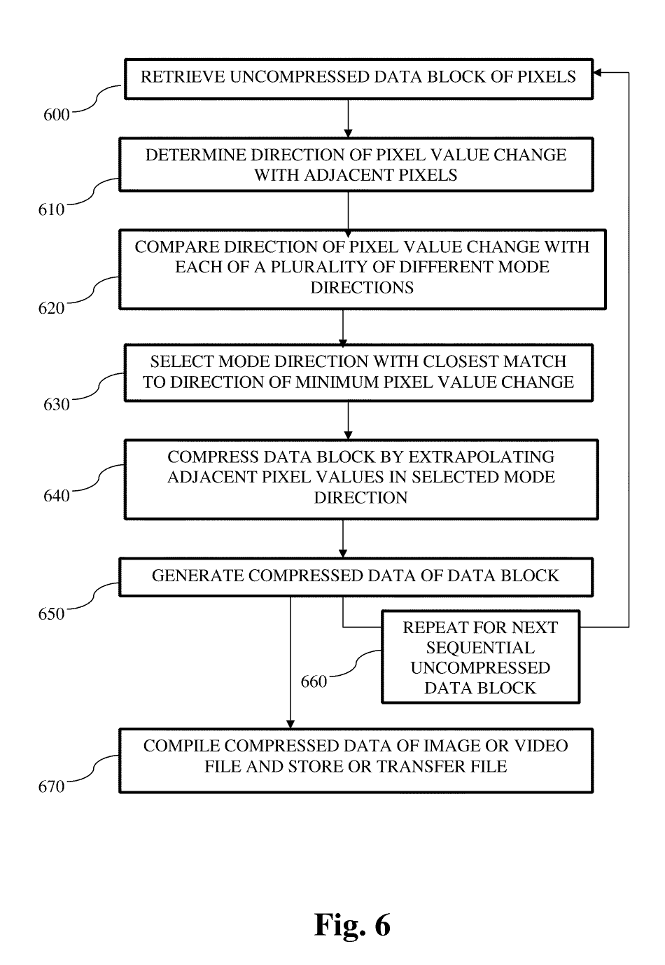

Reference is made to FIG. 6, which is a flowchart of a method implemented in a computing device for spatially encoding a data block of digital data, in accordance with embodiments of the invention.

In operation 600, a processor (for example, processor 1 of FIG. 2A) may retrieve an uncompressed data block (e.g., data block 300 of FIG. 3) from the data memory unit (for example, data memory unit 2 of FIG. 2A), for example, using a fetch unit (for example, fetch unit 12 of FIG. 2A). The uncompressed data block may define values for a set of pixels in video or image data. For example, the data block may be a 4×4 entry data block defining values for a 4×4 pixel array in an image frame or video stream.

In operation 610, a mode decision unit (for example, mode decision unit 7 of FIG. 2A) may determine one or more direction(s) of pixel value change in the data block relative to adjacent data blocks (for example, adjacent pixel blocks 302 of FIG. 3). The adjacent data block may represent a set of adjacent pixels that are already encoded or compressed in a previous iteration of operations 600-650. The direction of change in pixel values may include a vector field (for example, vector field of pixel value changes 318 of FIG. 3) defining the direction of change for each entry of the data block relative to surrounding entries (for example, a surrounding or overlapping 2×2 sub-block). Alternatively, the direction may be an approximation, average, medium, or mode, direction of (maximum or minimum) pixel value change. The direction(s) of change in pixel values may be determined by measuring pixel value changes between the data block and adjacent pixel blocks in two or more distinct or non-parallel directions. The direction of pixel value change may be defined by the vector sums of the respective non-parallel measurements.

In operation 620, the mode decision unit may compare the direction of pixel value change determined in operation 610 with each of a plurality of predefined different mode directions.

In operation 630, the mode decision unit may select the mode direction that most closely matches the direction of minimum pixel value change. The direction of minimum pixel value change has the most constant pixel values and in the optimal direction for copying or extrapolating adjacent pixel values. In one embodiment, the mode that is most perpendicular to (for example, having the smallest scalar product with) the one or more direction(s) of pixel value change most closely matches the direction of minimum pixel value change.

In operation 640, a mode prediction unit (for example, mode prediction unit 10 of FIGS. 2A and 2B) may compress the data block by extrapolating pixel values from the adjacent set of pixels in the selected mode direction. The adjacent pixel values are extrapolated in substantially the direction of minimum value change, where “substantially” the minimum direction deviates from an absolute minimum direction by at most the difference between the actual direction of minimum value change and the closest of the mode directions.

The mode prediction unit may generate a prediction block by extrapolating adjacent pixel values. The mode prediction unit may calculate the “prediction error” or the residual data between the approximated prediction block and the original uncompressed data block. The mode prediction unit may send the selected mode and residual data to an encoder unit.

In operation 650, the encoder unit (e.g., encoder unit 6 of FIGS. 2A and 2B) may generate compressed data defining the data block. The compressed data may include a string of bits defining the selected mode (for example, as 1-4 bits) and the residual data (for example, as a DCT that defines the coefficients of the residual data block).

In operation 660, the processor may repeat operations 600-650 for the next sequential uncompressed data block in the image frame or video stream.

In operation 670, the encoder unit may compile the compressed data for the entire image frame or video stream, for example, as a string of encoded bits. The encoder unit may issue the encoded bits piece-wise or together to a load/store unit (e.g., load/store unit 11 of FIG. 2A) for transferring the image frame or video stream, for example, for storage, transfer to another device, system, network, or display in an output device.

It may be appreciated that mode decision unit and mode prediction unit may be integral to or separate from the encoder unit and/or the processor and may be operatively connected and controlled thereby. Other operations or series of operations may be used, and the exact set of operations shown above may be varied.

Although 4×4 data blocks (representing values for a 4×4 pixel array) are described herein, it may be appreciated to persons skilled in the art that data blocks having any dimensions, for example, including 4×8, 8×4, 4×16, 8×16, 16×16, . . . data blocks, a one-dimensional string of data bits, or three-dimensional data arrays, may be used interchangeably according to embodiments of the invention. Although the size of the data blocks may affect the quality of encoding (for example, smaller blocks may provide better compression quality), the size of the data blocks generally does not affect the process by which the blocks are encoded.

Although embodiments of the invention describe data blocks representing values of an array or block of pixels, neither the data blocks nor the pixel blocks need be arranged in a block or array format. For example, the pixel arrays and data blocks may be stored in a memory or storage device in any configuration such as a string of values.

Although embodiments of the invention are directed to encoding uncompressed data, it may be appreciated by persons skilled in the art that these mechanisms may be operated, for example, in a reverse order, to decode compressed data.

Embodiments of the invention may include an article such as a computer or processor readable medium, or a computer or processor storage medium, such as for example a memory, a disk drive, or a USB flash memory, encoding, including or storing instructions which when executed by a processor or controller (for example, processor 1 of FIG. 2A), carry out methods disclosed herein.

Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

1. A method implemented in a computing device for encoding a data block of digital data, the method comprising:
receiving an uncompressed data block defining values for a set of pixels;
determining a direction of pixel value change between the set of pixels and a set of adjacent pixels which belong to one or more previously encoded data blocks;
comparing the direction of pixel value change with each of a predefined plurality of different mode directions;
selecting a mode direction that most closely matches a direction of minimum pixel value change; and
compressing the data block by extrapolating values from the set of adjacent pixels in the selected mode direction.

2. The method of claim 1, wherein pixel values are extrapolated in substantially the direction of minimum pixel value change.

3. The method of claim 1, wherein the mode direction selected is the mode direction most perpendicular to the direction of pixel value change.

4. The method of claim 1, wherein the direction of pixel value change is defined by a direction for each entry of the data block relative to surrounding entries.

5. The method of claim 1, comprising measuring the pixel value changes between the set of pixels and adjacent pixels in two or more non-parallel directions, wherein the direction of pixel value change is defined by the vector sums of the non-parallel measurements.

6. The method of claim 1, wherein extrapolating in executed in the selected mode direction when the selected mode direction is chosen over a non-directional mode.

7. The method of claim 6, wherein the selected mode direction is chosen when the direction of the selected mode is at least closer to the direction of minimum pixel value change, on average, than the directions of other modes.

8. The method of claim 1, comprising:
converting the compressed data block into uncompressed data of an image frame or video stream; and
displaying the image frame or video stream.

9. A processor for encoding a data block of digital data comprising:
a memory unit to store an uncompressed data block defining values for a set of pixels;
a mode decision unit to determine a direction of pixel value change between the set of pixels and a set of adjacent pixels which belong to one or more previously encoded data blocks, to compare the direction of pixel value change with each of a predefined plurality of different mode directions, and to select a mode direction that most closely matches a direction of minimum pixel value change;
a mode prediction unit to extrapolate values from the set of adjacent pixels in the selected mode direction; and
an encoder unit to use the extrapolated values to generate compressed data representing the uncompressed data block.

10. The processor of claim 9, wherein the mode prediction unit extrapolates pixel values in substantially the direction of minimum pixel value change.

11. The processor of claim 9, wherein the mode decision unit selects the mode direction most perpendicular to the direction of pixel value change.

12. The processor of claim 9, wherein the mode decision unit defines the direction of pixel value change by a direction for each entry of the data block relative to surrounding entries.

13. The processor of claim 9, wherein the mode decision unit measures the pixel value changes between the set of pixels and adjacent pixels in two or more non-parallel directions and defines the direction of pixel value change by the vector sums of the non-parallel measurements.

14. The processor of claim 9, wherein the mode prediction unit extrapolates pixel values in the selected mode direction when the mode decision unit chooses the mode direction over a non-directional mode.

15. The processor of claim 14, wherein the mode decision unit chooses the mode direction over the non-directional mode when the direction of the selected mode is at least closer to the direction of minimum pixel value change, on average, than the directions of other modes.

16. A system for encoding a data block of digital data, comprising:
a memory unit to store an uncompressed data block defining values for a set of pixels;
a mode decision processing unit to determine a direction of pixel value change between the set of pixels and a set of adjacent pixels which belong to one or more previously encoded data blocks, to compare the direction of pixel value change with each of a predefined plurality of different mode directions, and to select a mode direction that most closely matches a direction of minimum pixel value change;
a mode prediction unit to extrapolate values from the set of adjacent pixels in the selected mode direction; and
an encoder unit to use the extrapolated values to generate compressed data representing the uncompressed data block.

17. The system of claim 16, wherein the mode decision processing unit selects the mode direction most perpendicular to the direction of pixel value change.

18. The system of claim 16, wherein the mode decision processing unit measures the pixel value changes between the set of pixels and adjacent pixels in two or more non-parallel directions and defines the direction of pixel value change by the vector sums of the non-parallel measurements.

19. The system of claim 16, wherein the mode prediction unit extrapolates pixel values in the selected mode direction when the mode decision processing unit chooses the mode direction over a non-directional mode.

20. The system of claim 16, comprising:
a decode unit to convert the compressed data block into uncompressed data in an image frame or video stream; and
a display to display the image frame or video stream.
